(19) United States
(12) Patent Application Publication
(10) Pub. No.: US 2018/0375794 A1
(43) Pub. Date: Dec. 27, 2018

(54) PROACTIVE RESOURCE ACQUISITION BASED ON ANTICIPATED NEED

(71) Applicant: BANK OF AMERICA CORPORATION, Charlotte, NC (US)

(72) Inventors: Tracy Beth Greene, Mooresville, NC (US); Frederika Zipporah Morris Angus, Charlotte, NC (US); Emily Paige Bosin, Charlotte, NC (US); Kathleen Miranda Brand, Charlotte, NC (US); William Bradley Burks, Charlotte, NC (US); Deepak Joseph, Charlotte, NC (US); Karla Ramirez, Charlotte, NC (US); Laura Elizabeth Randall, Davidson, NC (US)

(21) Appl. No.: 15/630,284

(22) Filed: Jun. 22, 2017

(51) Int. Cl. H04L 12/911; G06F 3/048; G06F 9/50

(52) U.S. Cl. CPC H04L 47/823; G06F 3/01; G06F 9/5005; G06F 3/048

(57) ABSTRACT

Proactive acquisition of supplemental resources for interactions based on anticipated needs improves computer processing efficiency and storage requirements, as well as allowing for improved interactions over the Internet. More particularly, desired interactions of a user, previous interactions of the user, changes in available interactions for the user, and supplemental resources for which the user qualifies are used in combination to felicitate the improved interactions for the user, and which also results in the improved computer processing efficiency and storage of the interactions.

### FIELD

The present invention relates generally to providing supplemental resources for user interactions, and more particularly to utilizing desired interactions identified by the user and supplemental resources to enter into available interactions.

### BACKGROUND

Sending notifications to uses requires large quantities of data storage and large amounts of processing capacity. When an entity sends targeted notifications to users, there is a greater likelihood that the users actually take an action associated with the notification, and it reduces the amount of data storage and processing capacity required when compared to non-targeted notification. By sending notifications to a subset of users from a plurality of users (excluding other users), an entity reduce the data and storage and processing capacity without affecting the actions taken on such notifications. Therefore, there is a need for a system to more accurately and efficiently provide notifications.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer products, and methods are described herein for acquisition of supplemental resources based on anticipated needs. More particularly, embodiments of the invention related to receiving desired interactions from a user, accessing previous interactions of the user, monitoring changes in available interactions, and monitoring supplemental resources for which the user qualifies. Embodiments of the invention allow the user to enter into available interactions (e.g., automatically, with notification, or the like) utilizing supplemental resources.

Embodiments of the invention comprise systems, computer implemented methods, and computer program products for facilitating interactions based on anticipated need. The invention comprises receiving a request from a user to add one or more desired interactions to an interaction list, wherein the request is received from the user computer system. The invention further comprises identifying one or more previous interactions for the user based on a plurality of previous interactions, wherein the plurality of previous interactions are determined from interaction entity systems, resource entity systems, or the user computer systems. The invention includes monitoring changes in one or more available interactions, wherein the one or more available interactions are determined from the interaction entity systems. The invention also monitors supplemental resources for the interactions for which the user qualifies, wherein the interactions include the one or more desired interactions, the one or more previous interactions, and the one or more available interactions, wherein the supplemental resources for the interactions for which the user qualifies are accepted supplemental resources or non-accepted supplemental resources for which the user has qualified but not yet accepted. Moreover, the invention comprises determining one or more suggested interactions, wherein the one or more suggested interactions are determined based on the one or more desired interactions, the one or more previous interactions, the changes in the one or more available interactions, and the supplemental resources for the interactions. The invention includes entering into the one or more suggested interactions with an interaction entity, wherein the one or more suggested interactions are entered into by the resource entity on behalf of the user.

In further accord with embodiments of the invention, entering into the one or more suggested interactions comprises automatically entering into the one or more suggested interactions based on the determination of the one or more suggested interactions.

In other embodiments, the invention further comprises receiving an indication from the user to allow for automatically entering into the one or more suggested interactions.

In still other embodiments of the invention, the indication from the user is provided in the desired interaction list of the user and further comprises pre-approval limits, wherein the pre-approval limits comprise an interaction resource amount, an interaction quantity, an interaction time period, or an interaction entity, and wherein the pre-approval limits must be met before allowing the resource entity to automatically enter into the one or more suggested interactions.

In yet other embodiments of the invention, entering into the one or more suggested interactions comprises sending a notification to the user with the one or more suggested interactions, and receiving a selection of at least one of the one or more suggested interactions.

In further accord with embodiments of the invention, the notification for the one or more suggested interactions is provided in an integrated interface adjacent to the one or more previous interactions.

In other embodiments, the invention further comprises settling the interaction by applying a supplemental resource amount for the supplemental resources to a resource pool of the user, deducting an interaction resource amount from the resource pool of the user, and sending the interaction resource amount reduced by the supplemental resource amount to the interaction entity.

In still other embodiments, the invention further comprises settling the one or more suggested interactions by deducting an interaction resource amount reduced by the supplemental resources from a resource pool of the user, and sending the interaction resource amount reduced by a supplemental resource amount to the interaction entity.

In yet other embodiments of the invention, the interactions are transactions for products, wherein the one or more desired interactions are desired transactions for desired products in which the user is interested, wherein the one or more previous interactions are past transactions for the products, wherein the one or more available interactions are available transactions for the products currently available, and wherein supplemental resources are offers for the products for the transactions.

In further accord with embodiments of the invention, determining the one or more suggested interactions based on the one or more desired interactions comprises identifying the products available that meet the products on the desired interaction list of the user.

In other embodiments of the invention, determining the one or more suggested interactions based on the one or more previous interactions comprises determining when the one or more suggested interactions are needed to meet a time threshold for the one or more previous interactions.

In still other embodiments of the invention, determining the one or more suggested interactions based on the changes of the available interactions comprises determining when product resource amounts for the products meet a product resource threshold.

In yet other embodiments of the invention, determining the one or more suggested interactions based on the supplemental resources for the interactions comprises identifying timing, quantity, or resource amount requirements for the supplemental resources to determine when the user qualifies for the one or more suggested interactions.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1 illustrates a block diagram of a supplemental resource system, in accordance with embodiments of the present invention.

FIG. 2 illustrates a flowchart for a general process flow for utilizing supplemental resources, in accordance with embodiments of the present invention.

FIG. 3 illustrates flowchart for a process flow for determining interactions for a user based in part on desired interactions and supplemental resources, in accordance with embodiments of the present invention.

FIG. 4 illustrates an interface for a desired interaction list, in accordance with embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that provide for proactive acquisition of supplemental resources for interactions based on anticipated needs, which improves computer processing efficiency and storage requirements, as well as allowing for improved interactions over the Internet. More particularly, desired interactions of a user, previous interactions of the user, changes in available interactions for the user, and supplemental resources for which the user qualifies are used in combination to felicitate the improved interactions for the user, and which also results in the improved computer processing efficiency and storage of the interactions.

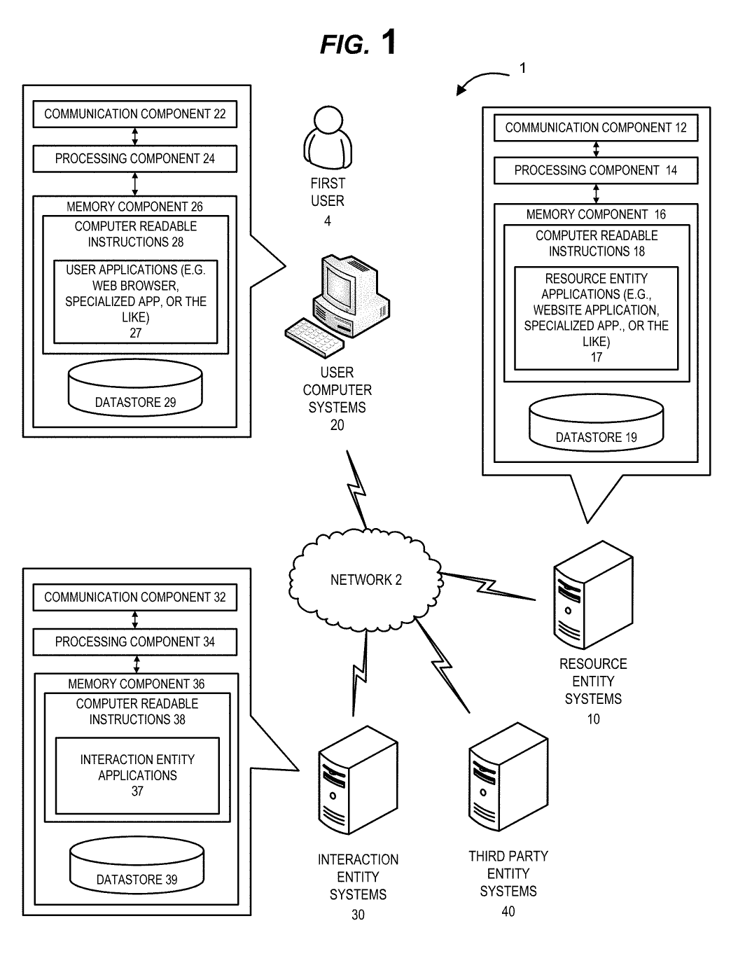

FIG. 1 illustrates a supplemental resource system environment 1, in accordance with embodiments of the invention. As illustrated in FIG. 1, one or more resource entity systems 10 are operatively coupled, via a network 2, to one or more user computer systems 20, one or more interaction entity systems 30, one or more third-party systems 40, and/or one or more other systems (not illustrated). In this way, the user 4 (e.g., one or more associates, employees, agents, contractors, sub-contractors, third-party representatives, customers, or the like), through a user application 27 (e.g., web browser, dedicated or specialized application, or the like), may access resource entity applications 17 (e.g., website, dedicated or specialized application, or the like) of the resource entity systems 10 to receive supplemental resources for interactions with interaction entities.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the resource entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, the interaction entity systems 30, third-party systems 40, or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the resource entity systems 10 comprise computer-readable instructions 18 stored in the memory component 16, which in one embodiment includes the computer-readable instructions 18 of the resource entity application 17 (e.g., website application, dedicated application, or the like). In some embodiments, the one or more memory components 16 include one or more data stores 19 for storing data related to the resource entity systems 10, including, but not limited to, data created, accessed, and/or used by the resource entity application 17. The resource entity application 17 may be utilized to provide and/or store not only resources for the user 4, but also supplemental resources for the user, and apply such supplemental resources to the interactions of the user 4.

As illustrated in FIG. 1, users 4 may access the resource entity application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22, the one or more image capture components 25, and the one or more memory components 26. The one or more processing components 24 use the one or more communication components 22 to communicate with the network 2 and other components on the network 2, such as, but not limited to, the resource entity systems 10, the interaction entity systems 30, third-party systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 1, the user computer systems 20 may have computer-readable instructions 28 stored in the one or more memory components 26, which in one embodiment includes the computer-readable instructions 28 for user applications 27, such as dedicated applications (e.g., apps, applet, or the like), portions of dedicated applications, a web browser or other apps that allow the user 4 to take various actions, including allowing the user 4 to access applications located on other systems, or the like. In some embodiments, the user 4 utilizes the user applications 27, through the user computer systems 20, to access the resource entity applications 17 to accept supplemental resources. Moreover, in some embodiments the user 4 may also utilize the user applications 27, through the user computer systems 20, to enter into interactions with the interaction entity, through the interaction entity applications 37 and/or interaction entity systems 30.

As illustrated in FIG. 1, one or more interaction entity systems 30 may communicate with the resource entity systems 10 and/or user computer systems 20 to provide supplemental resources to the resource entity and/or to engage in interactions with the user 4. As such, the interaction entity systems 30 are operatively coupled, via a network 2, to the one or more resource entity systems 10, the user computer systems 20, the third party systems 40, and/or other systems. The interaction entity systems 30 generally comprise one or more communication components 32, one or more processing components 34, and one or more memory components 36.

The one or more processing components 34 are operatively coupled to the one or more communication components 32, and the one or more memory components 36. The one or more processing components 34 use the one or more communication components 32 to communicate with the network 2 and other components on the network 2, such as, but not limited to, the components of the resource entity systems 10, the user computer systems 20, the third party systems 40, and/or other systems. As such, the one or more communication components 32 generally comprise a wireless transceiver, modem, server, electrical connection, or other component for communicating with other components on the network 2. The one or more communication components 32 may further include an interface that accepts one or more network interface cards, ports for connection of network components, Universal Serial Bus (USB) connectors and the like.

As illustrated in FIG. 1, the interaction entity systems 30 may have computer-readable instructions 38 stored in the one or more memory components 36, which in one embodiment includes the computer-readable instructions 38 of interaction entity applications 37 that allow for the interactions with the user 4 and/or the resource entity regarding supplemental resources, as will be described herein.

Moreover, as illustrated in FIG. 1, third party entity systems 40, and/or other like systems are operatively coupled to the resource entity systems 10, the user computer systems 20, and/or the interaction entity systems 30, through the network 2. The third party entity systems 40 and/or other like systems have components the same as or similar to the components described with respect to the resource entity systems 10, the user computer systems 20, and/or the interaction entity systems 30 (e.g., one or more communication components, one or more processing components, and one or more memory devices with computer-readable instructions of one or more applications, one or more datastores, or the like). Thus, the third party systems 40 and/or other like systems communicate with the resource entity systems 10, the user computer systems 20, the interaction entity systems 30, and/or each other in same or similar way as previously described with respect to the resource entity systems 10, the user computer systems 20, and/or the interaction entity systems 30.

The present invention disclosed herein relates generally to a resource entity providing a notification to a user that results in the user being able to take an action, such that a user may enter into a future interaction using user's resources from a resource pool and supplemental resources related to the notification and/or action. In some embodiments, the resource entity may be a financial institution and the interaction entity may be a merchant, but it should be understood that the entities may be another third party entity acting on its own or as a third-party for the resource entity or interaction entity. In some embodiments, the resource entity or the interaction entity may be acting on behalf of one another.

The notification may relate to supplemental resources (e.g., and offer, discount, rebate, or the like) that the user may utilize for a product (e.g., good or service) during an interaction (e.g., transaction, or the like) with an interaction entity. The notification may be presented to the user via various channels, such as through the user's online resource pool (e.g., online banking account, or the like), social network account, email, text message, or other like channel. In some embodiments, the user action may be the acceptance of the supplemental resources provided in the notification. When the user accepts the supplemental resources, the supplemental resources are activated so that if the user uses eligible resources from an eligible resource pool (e.g., as determined by the resource entity, the interaction entity, third party entity, or the like) to enter into the interaction, the user receives the benefit associated with the supplemental resources. In other embodiments, the supplemental resources may be automatically activated if the user has previously chosen to automatically activate supplemental resources associated with particular interactions (e.g., associated with particular interaction entities or products). In some embodiments, the resource entity may determine that a user may choose among multiple eligible resources pools in order to enter into an interaction associated with the supplemental resources. As will be described in further detail later, in some embodiments the present invention provides a targeted integrated interface that integrates information related to interactions that the user 4 has with interaction entities with resources used from the resource entities, and provides targeted supplemental resources to the user 4 through the targeted integrated interface.

The present invention provides at least three different improvements to the technological environment of interactions that occur over a network 2, such as the Internet. First, the present invention presents a targeted integrated interface that presents targeted supplemental resources to the user 4 in order to keep the user 4 within the resource entity systems 10 and to make the user 4 more likely to use the resources of the resource entity by providing supplemental resources to the user 4 for future interactions with various interaction entity systems 30. Secondly, the present invention allows a user to utilize a desired interaction list (e.g., a desired interaction integrated interface, or the like) with which the user 4 may include the user's desired interactions, and in some cases pre-approval limits, that allow the resource entity to automatically enter into interactions on behalf of the user 4. By allowing the resource entity to enter into interactions on behalf of the user 4, the resource entity receives a benefit in that it keeps the user 4 using the resources the user 4 has with the resource entity, and the user 4 also receives a benefit in that the user 4 is entering into interactions on the user's desired terms when the interactions become available and are most favorable to the user. Finally, the present invention improves the processing efficiency and reduces the storage capacity required by the resource entity systems 10 to present the targeted supplemental resources to the users 4. Because the targeted integrated interface is utilized to present the targeted supplemental resources to the user 4, the number of notifications presented to users 4 is greatly reduced because the notifications are specific to the user 4 and the user 4 can select the targeted supplemented resources that the user 4 wants to use as the user's convenience.

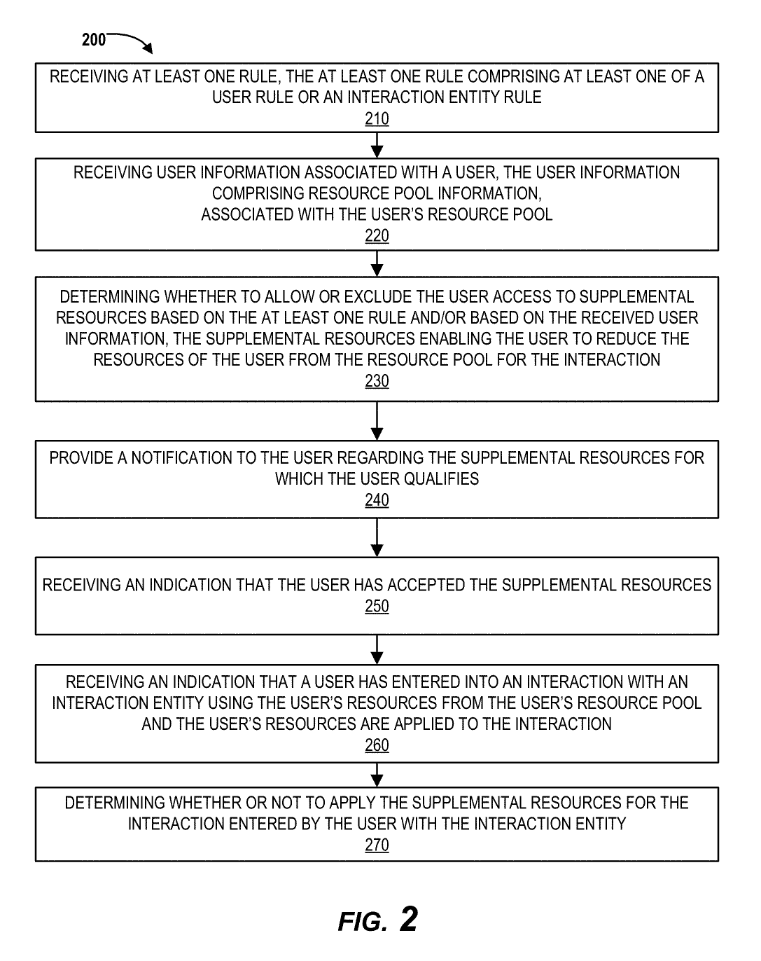

Referring now to FIG. 2, a general process flow 200 is provided for implementing rule-based supplemental resource association. At block 210, the method comprises receiving at least one rule, the at least one rule comprising at least one of a user rule or an entity rule (e.g., a filtering rule that excludes or allows the user access to supplemental resources based on the user and/or the entities). As used herein, a user rule is a rule that determines the users 4 that can access or that are excluded from the supplemental resources (e.g., allows or excludes some users from receiving and/or using the supplemental resources). In some embodiments, the at least one user rule may comprise an affinity rule. Therefore, if the user 4 and interaction entity already have an existing relationship (e.g., for providing and/or using supplemental resources), these users may be allowed or excluded from receiving the supplemental resources through the resource entity. The affinity rule comprises at least one of a full affinity rule or a partial affinity rule. When the affinity rule comprises a full affinity rule, the user is completely allowed or excluded from receiving supplemental resources if the interaction entity already has an existing relationship with the user 4. When the affinity rule comprises a partial affinity rule, the user 4 is allowed to or excluded from receiving supplemental resources associated with a particular product, category of products, an entity, industry, or the like associated with a particular interaction entity that already has an existing relationship with the user 4 for the particular product, category of products, entity, industry, or the like; however, the user 4 may receive supplemental resources associated with other products, categories of products, entities, industries, or the like associated with the particular entity. Additionally or alternatively, the user 4 may be allowed to or excluded from receiving supplemental resources associated with a competitor of a particular interaction entity if that particular interaction entity already has an existing relationship with the user 4.

In some embodiments, an entity rule is a rule that allows or excludes some interaction entities from providing supplemental resources to users 4 associated with an interaction entity. In some embodiments, the at least one entity rule comprises a category code rule. Therefore, an interaction entity associated with a predetermined category code (e.g., a healthcare code, or the like) is allowed to or excluded from providing supplemental resources. However, the resource entity managing the resource pool of the user 4 may set up a list of interaction entities that trigger exceptions. Interaction entities that trigger exceptions can provide supplemental resources even if these entities are associated with the excluded category codes.

It should be understood that specific user rules and/or entity rules have been described herein; however, any user rules or entity rules may be utilized to determine what users 4 have access to supplemental resources.

At block 220, the method comprises receiving user information associated with a user 4, the user information may comprise resource pool information associated with the user's resource pool. In some embodiments, resource pool information, as used herein, refers to information associated with the user's resource pool managed by one or more resource entities. In some embodiments, the resource pool information comprises an interaction history (e.g., a transaction history, or the like) associated with the user's resource pool. The interaction history includes the types of interactions, frequency of interactions, resources used for the interactions, entities involved in the interactions, resource balance history, or the like. As used herein, an interaction, may be a transaction such as a purchase, a deposit, a withdrawal, a credit, a debit, or the like associated with a resource pool.

In some embodiments, the user information comprises other information as well. For example, in some embodiments, the user information comprises personal information (e.g., demographic information, salary information, contact information (mailing address, email address, phone number, or the like), residence address history, education information, job profile information, or the like) associated with the user 4. In some embodiments, the personal information further comprises social network information associated with the user's social network account or other non-account related information associated with the user. In some embodiments, the user information further comprises user information (e.g., personal information, account information, or the like) associated with the user's immediate or extended family members or contacts (e.g., as determined from social network information). In some embodiments the social networking information may be captured by the resource entity systems 10 (or entity acting on its behalf) by accessing public social networking accounts of the user 4 or by accessing the user's private social networking account (e.g., by the user providing the resource entity system 10 the user's login and password or otherwise becoming a content of the resource entity system).

At block 230, the method comprises determining whether to allow a user 4 access to supplemental resources based on the at least one rule and/or based on the received user information. It should be understood that the resource entity may have agreements with interaction entities for providing supplemental resources to the user 4 if the user 4 enters into interactions with the interaction entities. The supplemental resources enable the user 4 to apply the supplemental resources to an interaction with an interaction entity in order to reduce the resources the user 4 uses from the user's resource pool to complete the interaction. As such, using the at least one rule and the received user information, the resource entity determines the targeted supplemental resources to present to the user 4. By using targeted supplemental resources, the resource entity can identify the users 4 most likely to use the supplemental resources in order to keep the users from leaving the resource entity applications 17 and keep the user's using the resources of the resource entity for the interactions with the interaction entities, and also reduces the storage capacity and processing capacity required to present the supplemental resources to the users 4 (e.g., because the supplemental resources are targeted to specific users 4 and not sent out randomly).

At block 240 in FIG. 2, when a user 4 qualifies for supplemental resources the resource entity may provide a notification to a user 4 regarding the supplemental resources. It should be understood that the user may receive a notification regarding the targeted supplemental resources from the resource entity. For example, the notification of the supplemental resources may be presented to the user 4 through the resource entity application 17 (e.g., user's online account accessed through the user computer systems 20), the social networking account of the user 4, electronic communication with the user 4 (e.g., user's e-mail, text message, sms message, other messaging channel, or the like), or the like, as will be described in further detail later.

As illustrated by block 250, regardless of how the supplemental resources are presented, an indication of an action is received regarding the one or more supplemental resources accepted by or for the user 4. The user 4 may take an action by accepting one or more of the supplemental resources presented to the user 4. In other embodiments of the invention, one or more of the plurality of supplemental resources may be added automatically based on the one or more supplemental resources determined for the user 4 as previously discussed with respect to block 230 (e.g., all of the supplemental resources for the user 4 are automatically added, or the like).

At block 260 an indication is received that a user 4 has entered into an interaction with an interaction entity using the user's resources from the resource pool of the user 4 at the resource entity. The indication may include the product associated with the interaction, the amount of the interaction, and/or the resource pool used by the user 4 to enter into the interaction. Should the interaction be allowed (e.g., there are no interaction limits on the user preventing the interaction, the interaction entity is allowed, the user's resource pool can cover the balance, or the like) resources from the user's resource pool are allocated for the interaction.

At block 270, as will be described, in some embodiments, the supplemental resources may be applied at a point of time in the future when the interaction that qualifies for the supplemental resources is processed.

In some embodiments, when an interaction is processed by the resource entity at a time in the future (e.g., at settlement time or processing time after the interaction is entered), the system determines whether the supplemental resources are still active and whether the supplemental resources are still valid with respect to both the user 4 and the interaction entity interacting with the user 4. This post-transaction process may be referred to as a supplemental resource reconciliation process. The supplemental resources are still active if the supplemental resources have not been revoked by at least one of the resource entity or the interaction entity, and/or if the supplemental resources have not expired.

The supplemental resources are valid with respect to the interaction entity if the interaction entity is not excluded under any entity rules. In some embodiments, in order for the supplemental resources to be valid, the interaction entity cannot be excluded under any entity rules that were in force at the time of the interaction. Additionally or alternatively, in some embodiments, in order for the supplemental resources to remain valid, the interaction entity cannot be excluded under any entity rules that are in force at the time of settlement of the interaction. Therefore, in some embodiments, the interaction entity cannot be excluded under any new entity rules that have been introduced since the interaction.

The supplemental interactions are valid for the user 4 if the user 4 is not excluded under any user rules. In some embodiments, in order for the supplemental resources to be valid, the user 4 cannot be excluded under any user rules that were in force at the time of the interaction. Additionally or alternatively, in some embodiments, in order for the supplemental resources to remain valid, the user cannot be excluded under any user rules that are in force at the time of settlement of the interaction. Therefore, in some embodiments, the user cannot be excluded under any new user rules that have been introduced since the purchase transaction.

In still other embodiments of the invention, the supplemental resources may also meet specific interaction rules (e.g., transaction rules) regarding the interaction of the user with the interaction entity. The interaction rules may be set by the interaction entity and/or the resource entity. For example, the interaction rules may require the user 4 to enter the interaction at a specific date, time of day, location, interaction channel (e.g., in person, over the Internet, over a telephone, or the like), for a specific amount of resources, or the like. Moreover, the interaction rules may require the user 4 to use resources from specific resource pools.

If the user rules, interaction entity rules, and/or the interaction rules are met at the time of the interaction and/or time of settlement, the supplemental resources are still valid and the resource entity applies the supplemental resource amount to the user's resource pool and/or reduces the resource amount provided to the interaction entity by the supplemental resources. In some embodiments, if at least one of the user rules, interaction entity rules, and/or the interaction rules are not met at the time of the interaction and/or settlement, the supplemental resources are invalid and the resource entity does not apply the supplemental resource amount to the user's resource pool and/or applies the full resource amount to the interaction entity. In alternate embodiments, even if at least one of the user rules, interaction entity rules, and/or interaction rules are not met at the time of settlement, the supplemental resources remain valid as long as the all of the rules were met at the time of the interaction, and consequently the resource entity applies the supplemental resource amount to the user's resource pool and reduces the resource amount provided to the interaction entity by the supplemental resource amount.

In some embodiments, the supplemental resources (e.g., a notification of the access to the supplemental resources) are presented via at least one of a targeted integrated interface associated with the user's resource pool (e.g., online banking account, mobile banking account on a portable mobile communication device, or the like), via a targeted integrated interface associated with the user's social network account, or the like. In some embodiments, a notification of the supplemental resources is presented adjacent to, such as inserted into or presented alongside (e.g., on the right, left, top, bottom side of an electronic interfaces related to an interaction with an interaction entity), the interaction history that is presented on the user's online resource pool interaction interface (e.g., online interaction account interface).

Therefore, for example, if ten interactions are listed in the interaction history list, the notification of the supplemental resources may be presented between the fourth and fifth interactions on the list. In some embodiments, the notification of the supplemental resources may be related to the transaction which the offer is presented alongside (e.g., the fourth and/or fifth transaction in the above example). For example, if the fourth interaction is a transaction for product ‘A’ from interaction entity ‘A,’ the supplemental resources are for a transaction for product ‘A’ (e.g., from any interaction entity) or for a transaction from interaction entity ‘A’ (e.g., for any product) or for a transaction of product ‘A’ from interaction entity ‘A.’ Alternatively, the supplemental resources may be for a transaction of a substitute product ‘A’ (e.g., from interaction entity ‘A’ or from any other interaction entity).

In other embodiments of the invention, the supplemental resources may be provided as an alert within the resource entity application 17 (e.g., online interaction account), which when selected may provide a targeted integrated interface with a plurality of supplemental resources for which the user 4 qualifies. In some embodiments, the notification for the supplemental resources is transmitted to the user's email account. In other embodiments, the notification for the supplemental resources is transmitted, via text message or the like, to the user's mobile device.

In some embodiments, the presented supplemental resources are related to at least one of an interaction previously entered by the user (e.g., a previous transaction associated with the user's financial institution account), an interaction from an interaction entity from which the user previously entered into an interaction, an alternative to the interaction previously entered into by the user, or an alternative to the interaction from the interaction entity from which the user previously entered into an interaction. The alternative to the interaction may be determined based on interaction histories associated with a plurality of resource pools associated with multiple users. In some embodiments, the presented notification for the supplemental resources relates to a new product related to a previous product interaction made by the user. For example, if the user previously bought a stove, the supplemental resources may be related to a dishwasher or a stove maintenance service.

In some embodiments, a notification of supplemental resources sent to or presented on a resource pool associated with a first member of a family may be used by a second member of the family. In some embodiments, the second member of the family may use the supplemental resources even if the second member is not associated with the resource pool associated with the first member. For example, the supplemental resources associated with a particular interaction entity may be transmitted to (or linked to) a resource pool associated with a first family member. When the second member of the family enters an interaction that qualifies for the supplemental resources using the second member's resource pool (e.g., any qualifying payment method), the second member receives the allocation of the supplemental resources after entering into the interaction. The resource entity may have access to information that indicates that the second member is a family member of the first member even if the second member is not listed as being associated with the resource pool associated with the first member.

Additionally, in some embodiments, as part of the previously described supplemental resources reconciliation process at the time of settlement of the supplemental resources, the system determines whether the resource pool information substantially matches the supplemental resources information. If the resource pool information has changed since the interaction such that the resource pool information no longer substantially matches the supplemental resources information, the supplemental resources may be deemed to be invalid and the resource entity does not provide allocation of the supplemental resource amount to the user's resource pool. However, in other embodiments, even if the resource pool information has changed since the interaction, the offer remains valid and the financial institution provides a rebate to the user's financial institution account.

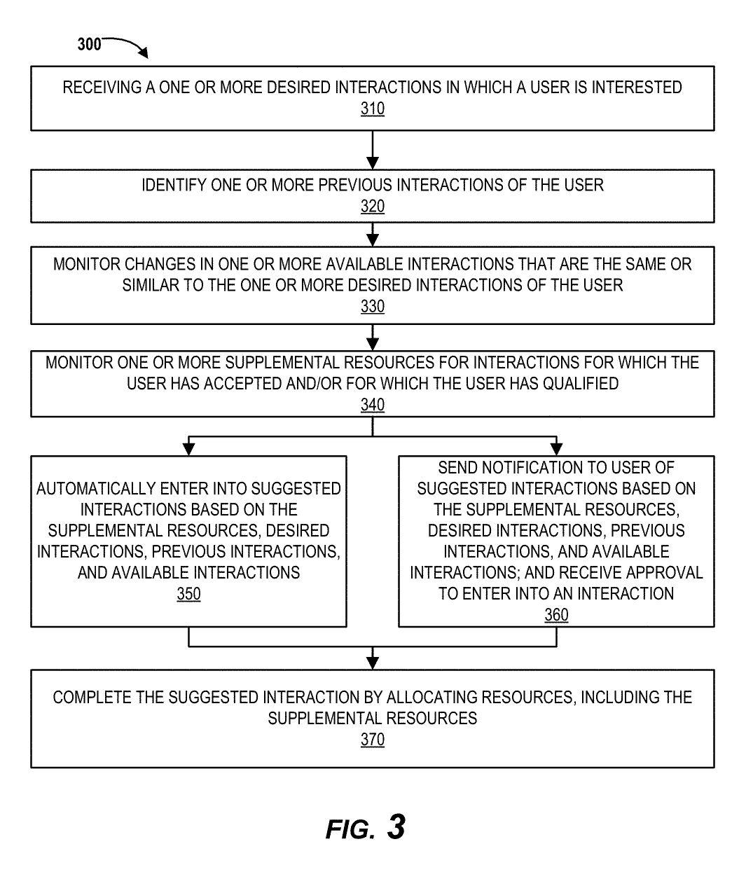

FIG. 3 illustrates a process flow for determining interactions for a user based in part on desired interactions and supplemental resources. In some embodiments of the invention the interactions may be proactively entered based on anticipated need from reviewing previous interactions, as well as from a desired list of interactions, the resource amounts associated with desired interactions and/or previous interactions that are currently available, and/or the supplemental resources for which the user 4 has qualified (e.g., qualified and selected, or qualified but not yet accepted).

FIG. 3 illustrates in block 310 that one or more desired interactions in which a user 4 is interested is received. In one example, the user indicates the one or more interactions (e.g., transactions for products) to a list (e.g., a transaction cart, wish list, or the like) to indicate the products in which the user 4 is interested. In one embodiment, the user 4 may select the interactions through the user application 27 on the user computer system 20 while connected to a resource entity application 17 through the resource entity systems 10, or through the interaction entity systems 30 and/or third-party entity systems 40. In some embodiment the selection of the interaction may be based on products that the user 4 is presented by the resource entity through the use of an integrated interface. The integrated interface may be a list of previous interactions of the user 4 that includes the references to available interactions and/or supplemental resources associated with available interactions for which the user 4 has qualified. The integrated interface may further be an interface of interactions based on all the supplemental resources for which the user 4 has qualified, and thus the user 4 may select the one or more supplemental resources that the user 4 would like to accept in order to indicate an interaction in which the user 4 is interested. Alternatively, the integrated interface my include a social networking interface, search results interface, or other like Internet browser or dedicated application interface, any of which may be used to receive an indication from a user 4 that the user is interested in a particular interaction and/or supplement resources for an interaction.

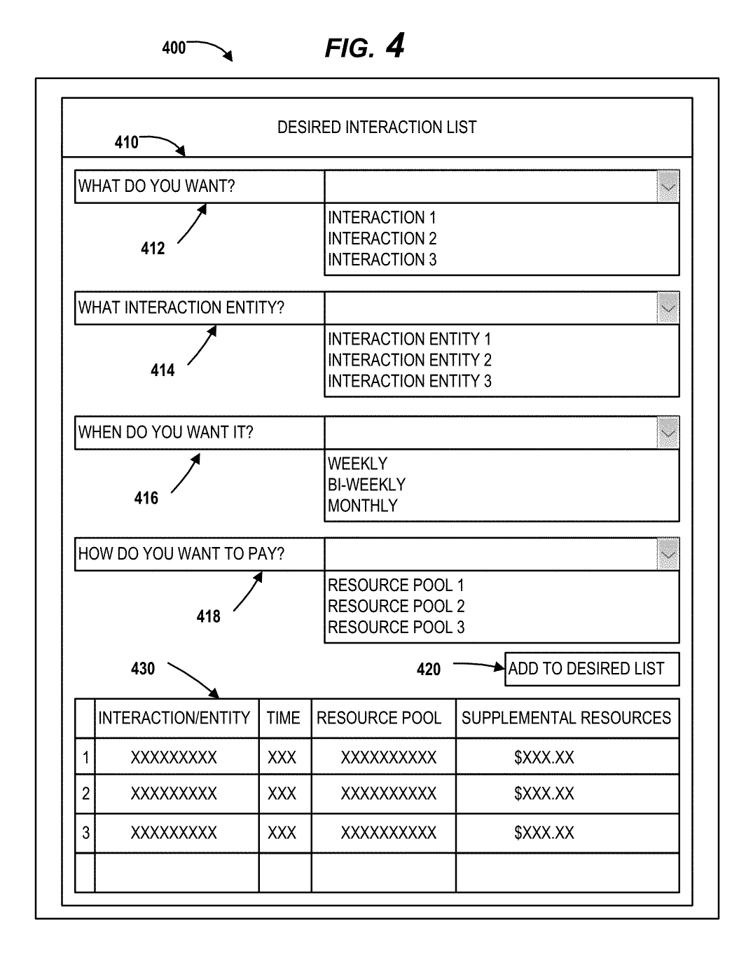

One example of a desired interaction integrated interface 400 may include a desired interaction list, such as a shopping list, wish list, or the like, as illustrated in FIG. 4. As illustrated in FIG. 4, the desired interaction list interface 400 may include a desired interaction selection section 410 and a desired interaction list section 430. The desired interaction selection section 410 may include an interaction selection 412 (e.g., a product or transaction selection), which allows a user to select a particular interaction in which the user 4 may be interested. The desired interaction selection section 410 may also include an interaction entity selection 414 (e.g., a merchant selection), which allows a user 4 to select an interaction entity with which the user 4 would like to enter into an interaction. The desired interaction selection section 410 may further include an interaction time period selection (e.g., a recurring interaction period), which allows the user 4 to indicate how frequently the desired interaction should occur. The desired interaction selection section 410 may further include an interaction resource pool section (e.g., a user account selection), which allows the user 4 to select the resource pool that should be used for the interaction. It should be understood that the desired interaction selection section 410 may include other selections that have been described herein, but not specifically illustrated in the example in FIG. 4. Moreover, it should be understood that the user 4 may leave one or more of the selections blank or may select all (e.g. all resource pools, all interaction entities, or the like) and in response the resource entity may search for all selections that are relevant (e.g., search all interaction entities). The desired interaction selection section 410 may further include an “add to” desired list selection feature 420 (e.g., button, or the like) that adds the interaction to the user's desired interaction list.

The desired interaction integration interface 400 may further include a desired interaction list section 430 that provides the list of the interactions in which the user 4 is interested. As illustrated in FIG. 4, the desired interaction list may include the interaction entity, the time period for which the interactions should be entered, and the resource pool(s) that should be used for the interaction. In some embodiments the desired interaction list may be embedded with an indication of the supplemental resources (e.g., offer, offer amount, or the like) for which the user has qualified and/or accepted in order to illustrate the available supplemental resource associated with a particular interaction. The user 4 may be able to accept supplemental resources that are made available to the user 4 in the desired interaction list section 430 of the interface 400 (e.g., integrated interface). The user 4 may also be able to add, edit, or delete interactions in the interface 400. As is described throughout herein, the desired interactions (e.g., the desired interactions included in the desired interaction integrated interface 400) may be used by the resource entity in order to identify suggested interactions for the user 4.

Block 320 of FIG. 3 illustrates that the previous interactions of the user 4 are identified. As described herein, in some embodiments the previous interactions may be transactions for products that the user 4 has made in the past. The identification of the previous interactions may include identifying the previous interaction information. The previous interaction information may include the timing of the previous interactions, such as but not limited to periodic timing (e.g., the time of year, month, day, or the like), frequency timing (e.g., how many times during the periodic timing), the quantity timing (e.g., quantity as it relates to the periodic timing), or other like timing information. The timing of the previous interactions may include timing thresholds. The timing thresholds may proactively provide indications to the resource entity when the user 4 may need to enter into interactions. For example, if a user typically enters into an interaction twice a month, and a month has almost passed with the user only having entered into one interaction, it may indicate that the user 4 may like to enter another interaction before the month is over. The previous interaction information for the previous interactions may be one factor used in determining suggested interactions for the user 4.

It should be understood that the previous interactions and associated previous interaction information may be captured from a number of sources, for example, but not limited to the resource entity through which the supplemental resources are provided to the user, other resource entities (e.g., other institutions through which the user 4 has access to resources), interaction entities (e.g., the interaction entities though which the users enter into interactions), other third-party entities (e.g., budgeting aggregators, or other entities that collect interaction information for the user in a central location). The previous interactions may be captured by the resource entity system 10 communicating with the user computer systems 20, the interaction entity systems 30, and/or the third-party 40.

FIG. 3 further illustrates in block 330 that changes in available interactions that are the same as or similar to the desired interactions of the user 4 are monitored. For example, the resource entity 10 alone, or based on information provided by the interaction entity systems 30 or third-party entity systems 40, may monitor changes in the resource amount of the interactions (e.g., costs of products in the transaction) that are the same as or similar to the desired interactions that the user added to the user's desired list. The interactions that are the same as or similar to the desired interactions on the user's desired list may include transactions for the same products with the same entity as included on the user's desired list, transactions for products that perform the same function, or transactions for the products that are the same as the products on the user's desired list but are provided by a different entity. For example, the resource entity systems 10 may monitor the changes in the resource amount (e.g., prices) of the same or similar products that are on the user's desired list in order to determine when the interaction reaches an acceptable amount, such as when the amount hits a threshold. As such, in some embodiments, the resource amount for particular interactions may be monitored across multiple interaction entities (e.g., amount comparison) until the resource amount from at least one of the interaction entities reaches a resource amount threshold that indicates a point at which the user 4 may be interested in entering the interaction. The resource amount threshold may be based on input provided by the user 4 (e.g., a user defined resource threshold threshold), or may be based on a determination made by analyzing the user's previous transactions (e.g., enter the interaction when the resource amount for the interaction meets the resource amount of the previous interaction). Alternatively, the resource entity system 10 may monitor when a particular interaction becomes available (e.g., goes on the market, is available in a particular region, meets a quantity requirement, or the like). It should be understood that the resource entity systems 10 may do the monitoring, a third-party may do the monitoring for the resource entity, or an interaction entity may send the information to the resource entity when an interaction reaches a certain resource amount, availability, or the like.

Block 340 of FIG. 3 indicates that the supplemental resources for interactions which the user has qualified (e.g., accepted and/or for which the user has been provided but not yet accepted) are monitored. In one embodiment the resource entity systems 10 may compare the supplemental resources for which the user has qualified with the user's desired interactions, previous interactions, and/or available interactions. In some embodiments, the user's desired interaction list and an accepted supplemental resources list may be a single integrated interface. For example, the integrated interface may include both an indication of the user's desired interactions that the user has added to a desired interaction list, as well as the supplemental resources available for the desired interaction list. As such, the desired interaction list may include an integrated interface of both the user's desired interactions as well as the supplemental resources for which the user has qualified. In other embodiments of the invention, the resource entity may take the desired interaction list and compare the list of desired interactions with all available supplemental resources for which the user 4 has qualified (e.g., regardless of whether or not the user has accepted the supplemental resources). Moreover, in some embodiments the resource entity may take the desired interaction list and compare the list to the user's previous interactions. It should be understood, that the resource entity systems 10 may do the monitoring, a third-party may do the monitoring for the resource entity, or an interaction entity may send the supplemental resource information to the resource entity when the supplemental resources become available and/or when the user 4 qualifies for the supplemental resources. As such, the available supplemental resources for which the user has qualified may be another factor in determining the suggested interactions for the user 4.

FIG. 3 illustrates in block 350 that the resource entity system (or the third-party on behalf of the resource entity system) may automatically enter into interactions based on the desired interaction list of the user 4, the previous interactions of the user 4, the monitoring of the changes in the available interactions that are the same as or similar to the desired interactions or previous interactions of the user 4, and/or the monitoring of the supplemental resources for which the user 4 has qualified. For example, when the resource entity system identifies a transaction for a product that is listed on the user's desired interaction list, the product meets timing thresholds (e.g., the past transaction occurred outside of, or near the end of, a time period in which the user has indicated more of the product is needed), the amount of the transaction for product meets an amount threshold (or other threshold is met), and/or the user qualifies for supplemental resources, the system may automatically enter into the interaction. In some embodiments, the threshold for the transaction amount may be independent of the supplemental resource amount available or may be in addition to the supplemental resource amount. As such, there may be a set amount for the transaction in which the user 4 is interested, and the set transaction amount may be based solely on the amount of the product, solely based on the supplemental resource amount, or based on the combination of the resource amount after incorporating the supplemental resource amount.

In some embodiments of the invention, in order to automatically enter into interactions on behalf of the user 4, the user may provide permission for the resource entity system to enter into interactions. For example, the user 4 may indicate that the resource entity may enter into all interactions for the user 4, all interactions on the user's desired interaction list, or specific interactions selected by the user 4 on the user's desired interaction list. As such, in some embodiments, the user 4 may provide pre-approval for the resource entity to enter into specific interactions on the user's desired interaction list, and may also place pre-approval limits on the automatic interactions, for example, threshold limits for interaction resource amounts, interaction quantities, interaction time periods, interaction entities, interaction location, and/or the like.

In other embodiments of the invention, as illustrated by block 360 in FIG. 3, after a determination is made of suggested interactions, instead of automatically entering into the interaction, a notification is sent to the user 4 for approval to enter into the interaction. In response, user approval may be received from the user 4 to enter into the interaction. The notification may be presented to the user 4 through a number of different channels. In some embodiments, the notification is sent to the user 4 through one or more integrated interfaces, such as the one or more integrated interfaces described herein (e.g., the integrated interfaces on the resource entity application 17 that the user is accessing through the user application 27). In other embodiments of the invention, the notification is presented to the user through e-mail, text message, or other like communication channel.

In some embodiments the interaction may be scheduled for automatic entry, but a notification may also be sent to the user 4, not for approval to enter into the interaction, but to notify the user 4 that an interaction is about to occur (e.g., pending interaction). In response, the user 4 may be able to respond to the pending interaction notification in order add additional interactions (e.g., transactions for additional products) to the current pending interactions. In other embodiments, the user 4 may be able to move up, move back, or delete the interaction that is about to occur in response to the pending interaction notification.

As illustrated by block 370 in FIG. 3, regardless if the interaction is entered into automatically or through user notification and acceptance, the interaction is completed as previously discussed with respect to FIG. 2. As previously discussed, in one embodiment of the invention, the interaction occurs between the user 4 and the interaction entity systems 30 using resources of the user 4 through the resource entity system 10 without taking into account the supplemental resources for which the user has qualified. Thereafter, at a later point in the time, such as during settlement, the supplemental resources are applied to the user's resource pool (e.g., account) and the resource entity provides the resource amount for the interaction to the interaction entity after deducting the supplemental resource amount from the resource amount. In alternative embodiments of the invention, the resource entity may settle the interaction by applying the supplemental resource amount to the user's account and/or to the resource amount for the interaction and applying the full amount of the resources to the interaction entity. Thereafter, at a later point in time the resource entity may bundle of all of the supplemental resources for multiple interactions from multiple users 4 with the interaction entity into a single request for a time period (e.g., all interactions that occur during a day, week, month, or the like) and request that the interaction entity provides the bundled supplemental resource amount to the resource entity for the time period at one time.

It should be further understood that in some embodiments of the invention, since the resource entity interaction is scheduling the user's interactions in advance, the resource entity may interact directly with the interaction entity and bypass the traditional channels for processing of interactions (e.g., payment processing channels with a clearinghouse, resource pool intermediary, such as a card issuer, or the like). During typical transaction processing the resource entity and/or the interaction entity are not aware that an interaction is about to take place, as such, when the user 4 enters into an interaction, the interaction is run through third party verification to determine if the user 4, the interaction entity, and/or the resource entity are all the proper parties for the interaction, that the resources are available and the interaction is acceptable. Alternatively, because the interaction of the present invention is scheduled through the resource entity all the information is already known before the interaction actually occurs and the interaction is routed directly between the resource entity and the interaction entity. As such, the resource entity may contact the interaction entity directly before entering into the interaction to indicate that the scheduled interaction is a trusted interaction that does not have to be verified through an interchange, or the like. The resource entity may enter the interaction on behalf of the user 4 and indicate to the interaction entity that the resources (with or without the supplemental resources being applied to the interaction) will be provided to the interaction entity on a particular day and/or time in exchange for the product provided by the interaction entity. Moreover, it should be understood that because the interaction does not have to be processed through a third-party, the resource entity and/or the interaction entity do not have to pay for the third-party processing (e.g., no interchange costs). As such, the entire amount saved on processing, or a portion thereof, may be passed on to the user 4, and/or kept by the resource entity and/or the interaction entity. Additionally, in some embodiments, because the interaction is scheduled, instead of the supplemental resource amount being applied after the interaction at settlement (e.g., rebate), the supplemental resource amount may be applied at the time of the interaction (e.g., discount).

Additionally, it should be understood that in some embodiments of the invention, the amount saved by the user 4, the supplemental resources, and/or additional supplemental resources that may be provided by the resource entity and/or the interaction entity for entering the transaction (e.g., additional discounts, rewards, or the like from the resource entity, and/or additional discounts, rewards, or the like from the interaction entity, in some cases due to the reduction of the interchange fees) may be applied to the present interaction and/or a portion may be deferred to additional scheduled interactions in the future.

Referring generally to the embodiments of the invention, supplement resources may be offers for discounts, rebates, and/or coupons (e.g., reverse couponing) that are applied to the user's resource pool retroactively after the interaction has been made. As such, the system enables transmission of individualized or personalized offers to users. For example, an offer associated with a merchant may be a 10% discount on a purchase made from that merchant. As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

In one example of the invention discussed herein, the user 4 may add products to the user's list of desired products. The list of desired products may include user's desired timing of the desired products (e.g., when the user would like to enter into interactions for the products), desired quantity of desired products (e.g., the user may only desire to enter into the interaction if there are a specific quantity of the products), desired one or more merchants with which the user would like to transact for the products (e.g., specific interaction entities with which the user would like to interact), desired location from which the products are received (e.g., regions within a state, group of states, countries, or the like from which the user would like to receive the products), or other desired requirements for the desired interactions for the desired products. The resource entity then identifies the user's previous interactions to determine past products for which the user 4 has entered into transactions. For example, the resource entity may identify products that the user purchases every month (or in a different time period), and identify that the user has yet to purchase the products in the current month (or other time period) or the user has yet to purchase the same quantity in the current month. The combination of the products on the user's desired list and the user's previous interaction history may result in the resource entity automatically purchasing the products for the user, as previously discussed herein. The resource entity may also monitor changes in available products, such as by monitoring the availability of products, the resource amount for the products, or the like. The combination of the monitoring the available products with the products on the user's desired interaction list and/or the user's previous transactions for products may result in the resource entity automatically entering a transaction for the products for the user 4, or sending a notification to a user to allow the resource entity to enter a transaction for the products for the user 4. As such, when the products from the user's desired products reach a threshold resource amount in the market, the resource entity may enter a transaction for the products. The resource entity also monitories the supplemental resources for products from various interaction entities. For example, the resource entity will determine what supplemental resources are available (e.g., the user has already accepted or for which the user has qualified but not yet accepted) to the user 4 or to apply to an interaction on behalf of the user 4 in order to automatically enter into an interaction for a product for the user 4 (or otherwise send a notification of the interaction to the user 4). The combination of monitoring the supplemental resources available to the user 4 for products in combination with the products on the user's desired interaction list, the previous products for which the user transacted, and/or available products from the interaction entities may result in the resource entity automatically entering an interaction for the products for the user 4, or sending an notification to a user 4. For example, when the combination of the resource amount of available products on the market in combination with the supplement resources (e.g., offer) for which the user qualifies meets a threshold resource amount for a product that the user has included on the user's desired products list, and the user's previous transactions for the product are not satisfied, the resource entity institution will automatically enter into the transaction for the product.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7879US1.014033.3037 | To be assigned | SYSTEM FOR LINKING | Concurrently |
| | | ALTERNATE RESOURCES | herewith |
| | | TO RESOURCE POOLS | |
| | | AND ALLOCATING | |
| | | LINKED ALTERNATIVE RESOURCES | |
| | | TO A RESOURCE INTERACTION | |
| 7880US1.014033.3038 | To be assigned | DYNAMIC UTILIZATION OF | Concurrently |
| | | ALTERNATIVE RESOURCES BASED | herewith |
| | | ON TOKEN ASSOCIATION | |
| 7882US1.014033.3040 | To be assigned | DATA TRANSMISSION TO | Concurrently |
| | | A NETWORKED RESOURCE BASED | herewith |
| | | ON CONTEXTUAL INFORMATION | |
| 7883US1.014033.3041 | To be assigned | DATA TRANSMISSION | Concurrently |
| | | BETWEEN NETWORKED | herewith |
| | | RESOURCES | |

What is claimed is:

1. A system for facilitating interactions based on anticipated need, the system comprising:
one or more memory devices having computer readable code store thereon; and
one or more processing devices operatively coupled to the one or more memory devices, wherein the one or more processing devices are configured to execute the computer readable code to:
receive a request from a user to add one or more desired interactions to an interaction list, wherein the request is received from the user computer system;
identify one or more previous interactions for the user based on a plurality of previous interactions, wherein the plurality of previous interactions are determined from interaction entity systems, resource entity systems, or the user computer systems;
monitor changes in one or more available interactions, wherein the one or more available interactions are determined from the interaction entity systems;
monitor supplemental resources for the interactions for which the user qualifies, wherein the interactions include the one or more desired interactions, the one or more previous interactions, and the one or more available interactions, wherein the supplemental resources for the interactions for which the user qualifies are accepted supplemental resources or non-accepted supplemental resources for which the user has qualified but not yet accepted;
determine one or more suggested interactions, wherein the one or more suggested interactions are determined based on the one or more desired interactions, the one or more previous interactions, the changes in the one or more available interactions, and the supplemental resources for the interactions; and
enter into the one or more suggested interactions with an interaction entity, wherein the one or more suggested interactions are entered into by the resource entity on behalf of the user.

2. The system of claim 1, wherein entering into the one or more suggested interactions comprises automatically entering into the one or more suggested interactions based on the determination of the one or more suggested interactions.

3. The system of claim 1, wherein the one or more processing devices are further configured to execute the computer readable code to:
receive an indication from the user to allow for automatically entering into the one or more suggested interactions.

4. The system of claim 3, wherein the indication from the user is provided in the desired interaction list of the user and further comprises pre-approval limits, wherein the pre-approval limits comprise an interaction resource amount, an interaction quantity, an interaction time period, or an interaction entity, and wherein the pre-approval limits must be met before allowing the resource entity to automatically enter into the one or more suggested interactions.

5. The system of claim 1, wherein entering into the one or more suggested interactions comprises:
sending a notification to the user with the one or more suggested interactions; and
receiving a selection of at least one of the one or more suggested interactions.

6. The system of claim 5, wherein the notification for the one or more suggested interactions is provided in an integrated interface adjacent to the one or more previous interactions.

7. The system of claim 1, wherein the one or more processing devices are further configured to execute the computer readable code to:
settle the interaction by applying a supplemental resource amount for the supplemental resources to a resource pool of the user, deducting an interaction resource amount from the resource pool of the user, and sending the interaction resource amount reduced by the supplemental resource amount to the interaction entity.

8. The system of claim 1, wherein the one or more processing devices are further configured to execute the computer readable code to:
settle the one or more suggested interactions by deducting an interaction resource amount reduced by the supplemental resources from a resource pool of the user, and sending the interaction resource amount reduced by a supplemental resource amount to the interaction entity.

9. The system of claim 1, wherein the interactions are transactions for products, wherein the one or more desired interactions are desired transactions for desired products in which the user is interested, wherein the one or more previous interactions are past transactions for the products, wherein the one or more available interactions are available transactions for the products currently available, and wherein supplemental resources are offers for the products for the transactions.

10. The system of claim 9, wherein determining the one or more suggested interactions based on the one or more desired interactions comprises identifying the products available that meet the products on the desired interaction list of the user.

11. The system of claim 9, wherein determining the one or more suggested interactions based on the one or more previous interactions comprises determining when the one or more suggested interactions are needed to meet a time threshold for the one or more previous interactions.

12. The system of claim 9, wherein determining the one or more suggested interactions based on the changes of the available interactions comprises determining when product resource amounts for the products meet a product resource threshold.

13. The system of claim 9, wherein determining the one or more suggested interactions based on the supplemental resources for the interactions comprises identifying timing, quantity, or resource amount requirements for the supplemental resources to determine when the user qualifies for the one or more suggested interactions.

14. A computer implemented method for facilitating interactions based on anticipated need, the method comprising:
receiving, by one or more processors, a request from a user to add one or more desired interactions to an interaction list, wherein the request is received from the user computer system;
identifying, by the one or more processors, one or more previous interactions for the user based on a plurality of previous interactions, wherein the plurality of previous interactions are determined from interaction entity systems, resource entity systems, or the user computer systems;
monitoring, by the one or more processors, changes in one or more available interactions, wherein the one or more available interactions are determined from the interaction entity systems;
monitoring, by the one or more processors, supplemental resources for the interactions for which the user qualifies, wherein the interactions include the one or more desired interactions, the one or more previous interactions, and the one or more available interactions, wherein the supplemental resources for the interactions for which the user qualifies are accepted supplemental resources or non-accepted supplemental resources for which the user has qualified but not yet accepted;
determining, by the one or more processors, one or more suggested interactions, wherein the one or more suggested interactions are determined based on the one or more desired interactions, the one or more previous interactions, the changes in the one or more available interactions, and the supplemental resources for the interactions; and
entering, by the one or more processors, into the one or more suggested interactions with the interaction entity, wherein the one or more suggested interactions are entered into by the resource entity on behalf of the user.

15. The method of claim 14, wherein entering into the one or more suggested interactions comprises:
receiving an indication from the user to allow for automatically entering into the one or more suggested interactions; and
automatically entering into the one or more suggested interactions based on the determination of the one or more suggested interactions.

16. The method of claim 15, wherein the indication from the user is provided in the desired interaction list of the user and further comprises pre-approval limits, wherein the pre-approval limits comprise an interaction resource amount, an interaction quantity, an interaction time period, or an interaction entity, and wherein the pre-approval limits must be met before allowing resource entity to automatically enter into the one or more suggested interactions.

17. The method of claim 14, wherein entering into the one or more suggested interactions comprises:
sending a notification to the user with the one or more suggested interactions; and
receiving a selection of at least one of the one or more suggested interactions.

18. The method of claim 14, wherein the interactions are transactions for products, wherein the one or more desired interactions are desired transactions for desired products in which the user is interested, wherein the one or more previous interactions are past transactions for the products, wherein the one or more available interactions are available transactions for the products currently available, and wherein supplemental resources are offers for the products for the transactions.

19. The method of claim 14, wherein determining the one or more suggested interactions based on the one or more desired interactions comprises identifying products available that meet the products on the desired interaction list of the user; wherein determining the one or more suggested interactions based on the one or more previous interactions comprises determining when the one or more suggested interactions are needed to meet a time threshold for the one or more previous interactions; wherein determining the one or more suggested interactions based on the changes of the available interactions comprises determining when product resource amounts for the products meet a product resource threshold; and wherein determining the one or more suggested interactions based on the supplemental resources for the interactions comprises identifying timing, quantity, or resource amount requirements for the supplemental resources to determine when the user qualifies for the one or more suggested interactions.

20. A computer program product for facilitating interactions based on anticipated need, the computer program product comprising at least one non-transitory computer-readable medium having computer-readable program code portions embodied therein, the computer-readable program code portions comprising:
an executable portion configured to receive a request from a user to add one or more desired interactions to an interaction list, wherein the request is received from the user computer system;
an executable portion configured to identify one or more previous interactions for the user based on a plurality of previous interactions, wherein the plurality of previous interactions are determined from interaction entity systems, resource entity systems, or the user computer systems;
an executable portion configured to monitor changes in one or more available interactions, wherein the one or more available interactions are determined from the interaction entity systems;
an executable portion configured to monitor supplemental resources for the interactions for which the user qualifies, wherein the interactions include the one or more desired interactions, the one or more previous interactions, and the one or more available interactions, wherein the supplemental resources for the interactions for which the user qualifies are accepted supplemental resources or non-accepted supplemental resources for which the user has qualified but not yet accepted;
an executable portion configured to determine one or more suggested interactions, wherein the one or more suggested interactions are determined based on the one or more desired interactions, the one or more previous interactions, the changes in the one or more available interactions, and the supplemental resources for the interactions; and
an executable portion configured to enter into the one or more suggested interactions with an interaction entity, wherein the one or more suggested interactions are entered into by the resource entity on behalf of the user.
